(19) United States
(12) Patent Application Publication
(10) Pub. No.: US 2024/0180368 A1
(43) Pub. Date: Jun. 6, 2024

(54) HOPPER FOR VERTICAL JUICER

(71) Applicant: I-TECH USA, INC., Farmington Hills, MI (US)

(72) Inventor: Dong Un Kim, Northville, MI (US)

(21) Appl. No.: 18/526,151

(22) Filed: Dec. 1, 2023

Related U.S. Application Data
(60) Provisional application No. 63/429,282, filed on Dec. 1, 2022.

(51) Int. Cl. A47J 43/046; A47J 43/07

(52) U.S. Cl. CPC A47J 43/046; A47J 43/0772

(57) ABSTRACT

The present disclosure provides a hopper for a vertical juicer. The hopper can include a body including a projection, a protrusion, and a rib. The projection, the protrusion, and the rib can be disposed on an interior of the body. The lid can be disposed adjacent to the body and configured to be coupled to the body. The lid can include a hole configured to receive food therethrough. The cutting mechanism can be rotatably coupled to the interior surface of the body and configured to cut food.

### CROSS-REFERENCE TO RELATED APPLICATIONS

This application claims the benefit of U.S. Provisional Application No. 63/429,282, filed on Dec. 1, 2022. The entire disclosure of the above application is incorporated herein by reference.

### FIELD

The present technology relates to a vertical juicer used to extract juice from a food, such as various fruits and vegetables.

### INTRODUCTION

This section provides background information related to the present disclosure which is not necessarily prior art.

Juicers have become a ubiquitous appliance in modern kitchens, essential for those seeking a healthier lifestyle and a quick way to incorporate more fruits and vegetables into their daily diets. While the focus is often on the juicing mechanism, the importance of an often-overlooked component cannot be denied—the hopper. The hopper is a vital part of the juicing process, and its design and functionality significantly influence the efficiency and convenience of juicing.

The hopper, typically positioned at the top of a juicer, serves as the entry point for fruits and vegetables into the juicing chamber. The design and functionality of the hopper play a crucial role in determining the ease of use, the speed of juicing, and the overall quality of the juice produced. Understanding the different aspects of hoppers can assist consumers with making more informed choices when selecting a juicer that suits their needs and preferences.

Hoppers for juicers come in various shapes and sizes, depending on the type of juicer and its intended purpose. Centrifugal juicers typically feature larger, circular hoppers capable of accommodating whole fruits and vegetables, making them ideal for quick and convenient juicing. On the other hand, masticating juicers usually have narrower, elongated hoppers designed for smaller pieces of produce, ensuring a slower but more efficient juice extraction process. Citrus juicers, specialized for oranges and lemons, have their own unique hopper designs. Each of these types of juicers can employ specific features within the hopper.

Hoppers often come with additional features that enhance the overall juicing experience. Some hoppers have wide-mouth openings to reduce the need for pre-cutting ingredients, saving time and effort. Others may include pusher tools to help feed produce into the juicer, ensuring safe and efficient operation. Many hoppers are designed with clear, transparent materials, allowing users to monitor the juicing process. These features contribute to the convenience and user-friendliness of juicers, making them more accessible and appealing to a wide range of consumers.

However, due to the cylindrical nature of hoppers, produce can easily become stuck along the sidewall of the hopper and accumulate. Produce that accumulates on the sidewall is often wasted as it avoids being juiced. Inefficient juicing can result and accumulated produce can require additional cleaning of the juicer.

Accordingly, there is a need for a vertical juicer that militates against food accumulating on the sidewalls of the juicer and increases juicing efficiency.

### SUMMARY

In concordance with the instant disclosure, a vertical juicer that militates against food accumulating on the sidewalls of the juicer and increases juicing efficiency has surprisingly been discovered. The present technology includes articles of manufacture, systems, and processes that relate to a hopper for a for a vertical juicer.

In certain embodiments, a hopper for a vertical juicer can include a body, a lid, and a cutting mechanism. The body can include a projection, a protrusion, and a rib. The projection, the protrusion, and the rib can be disposed on an interior of the body. The lid can be coupled to the body and can include a hole configured to receive food therethrough. The cutting mechanism can be disposed in the body and configured to cut food.

In certain embodiments, the hopper for the vertical juicer can include a body, a lid, and a cutting mechanism, where the body can include a projection, a protrusion, a rib, a cutout, a handle, and a safety mechanism. The projection, the protrusion, and the rib can be disposed on an interior of the body and the projection can include a rectangular cross section. The protrusion can be disposed opposite the projection within the interior of the body. The rib can have multiple ribs including a first set of ribs and second set of ribs. The first set of ribs can be disposed on a first side of the body between the projection and the protrusion. The second set of ribs can be disposed on a second side of the body between the protrusion and the projection. The cutout can be disposed on the interior of the body and can be disposed adjacent to the projection and can be configured to receive the cutting mechanism. The handle can be disposed on an exterior of the body and can include a lock switch mechanism. The lid can be hingedly coupled to the body and can include a hole configured to receive food therethrough. The lid can also include a tab configured to be received by the body. The cutting mechanism can be disposed in the body and can include a blade and an agitator. The blade can be configured to cut food.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front, top perspective view of a hopper for a juicer;

FIG. 2 is a rear, top perspective view thereof;

FIG. 3 is a top plan view of the hopper with a lid;

FIG. 4 is a top plan view of the hopper without the lid;

FIG. 5 is a cross sectional, top plan view of the hopper taken at section line A-A of FIG. 1;

FIG. 6 is a cut away elevational view of the hopper;

FIG. 7 is another cut away elevational view of the hopper;

FIG. 8 is a cross sectional, side elevational view of the hopper, shown having a closed lid and installed on a portion of the juicer, as taken at section line B-B of FIG. 2; and

FIG. 9 is a cross sectional, side elevational view of the hopper, shown having an open lid and installed on the portion of the juicer, as taken at section line B-B of FIG. 2.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

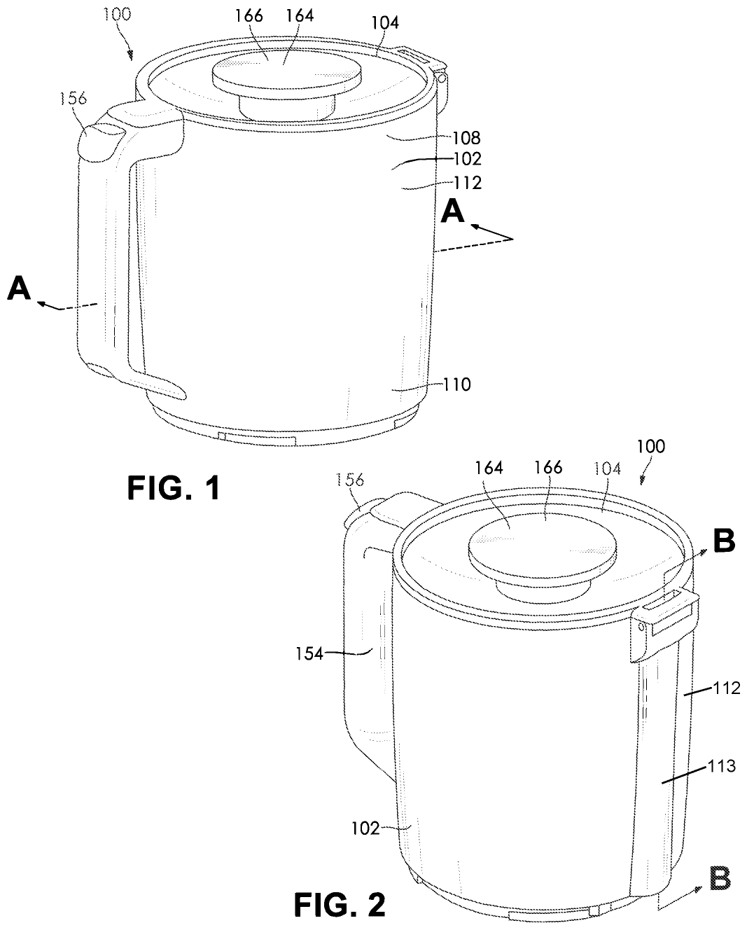

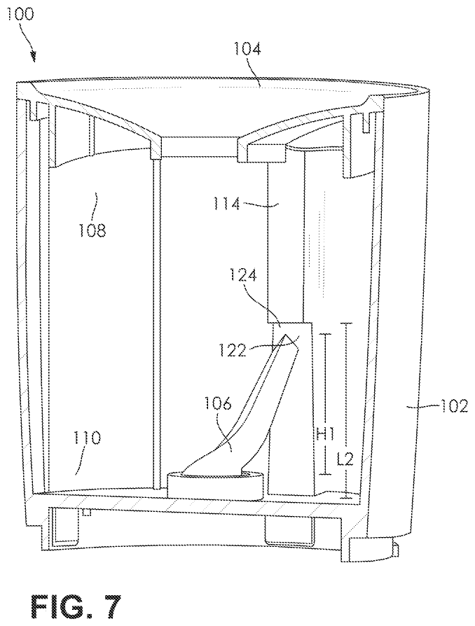

The present disclosure provides a hopper 100 for a vertical juicer 101, shown generally in FIGS. 1-9. The purpose of the hopper 100 is to facilitate juicing various foodstuffs and produce but, more specifically, to juice food effectively and efficiently by continually moving food toward the cutting mechanism of the juicer 101. Advantageously, this can provide the user with more juice while using less food. As shown in FIG. 7, the hopper 100 can include a body 102, a lid 104, and a cutting mechanism 106.

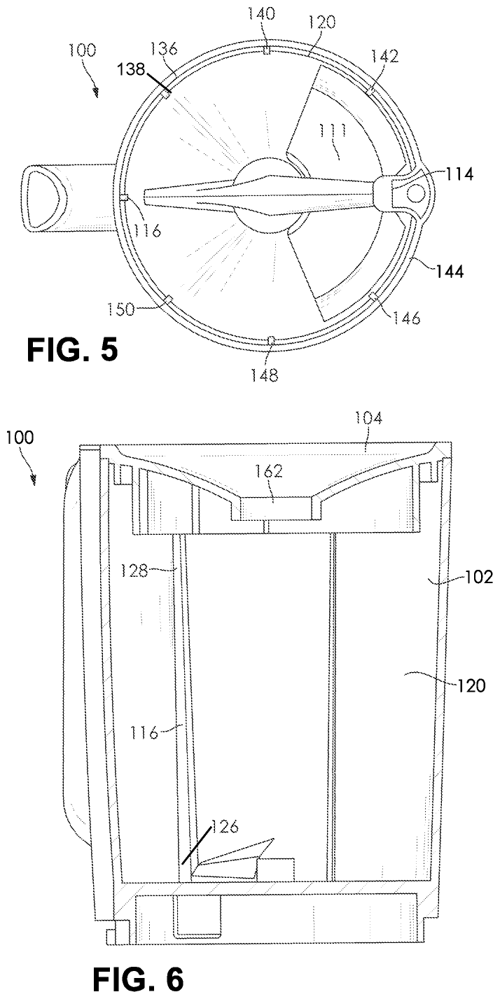

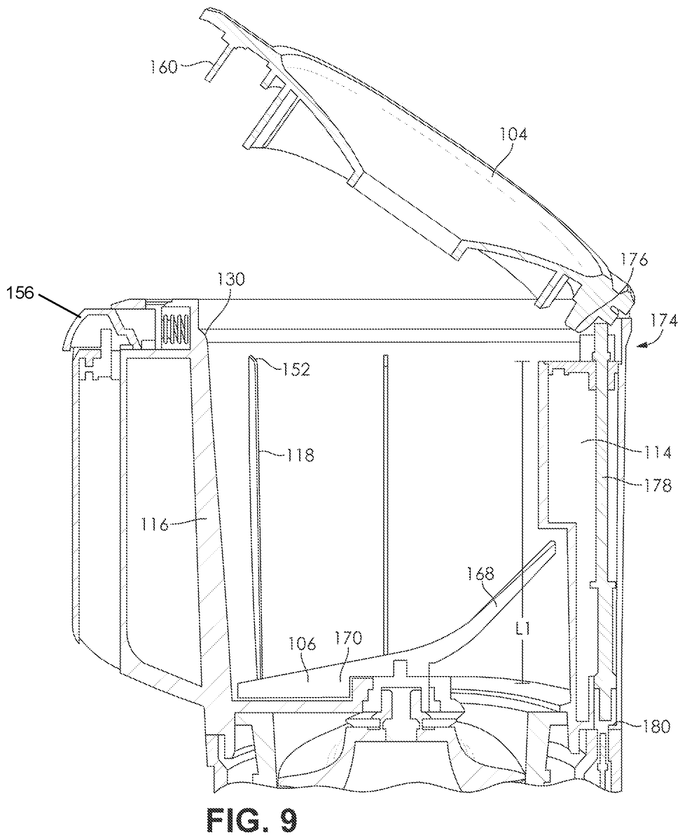

As shown in FIGS. 1-2 and 3-5, the body 102 can have a substantially circular cross section and be generally cylindrical in shape. The body 102 can taper from a top 108 of the body 102 to a bottom 110 of the body 102 to allow for the contents of the hopper 100 to move down the body 102 toward the cutting mechanism 106. The bottom 110 of the body 102 can include an opening 111 for juice to exit the body 102, as shown in FIG. 5. Additionally, with reference to FIG. 9, an exterior surface 112 of the body can include a spine 113 that extends outwardly from the exterior surface 112 of the body 102 along a length L1 of the body 102. One of ordinary skill can select other suitable shapes for the body 102 within the scope of the present disclosure.

With reference to FIG. 4, the body 102 can include a projection 114, a protrusion 116, and a rib 118. Each of the projection 114, the protrusion 116, and the rib 118 can be disposed on an interior surface 120 of the hopper 100. The projection 114, the protrusion 116, and the rib 118 can work to effectively move food down the hopper 100 for juicing.

It should be appreciated that the projection 114 can be disposed along the length L1 of the hopper 100, as shown in FIG. 9. Alternatively, the projection 114 can be disposed along a portion of the length L1 of the hopper 100. The projection 114 can include a cutout 122 disposed on a lower portion 124 of the projection 114, as shown in FIG. 7. The cutout 122 can include a substantially rectangular cross section. The cutout 122 can be configured to receive the cutting mechanism 106 during operation. As such, the cutout 122 can have a length L2 that accommodates the height HI of the cutting mechanism. Advantageously, the cutout 122 can allow the cutting mechanism 106 to rotate under the projection 114 and militate against food becoming stuck on the cutting mechanism 106 or interior surface 120.

As shown in FIG. 5, the projection 114 can include a substantially rectangular cross section. In an alternative embodiment, the projection 114 can include a triangular cross section. Advantageously, the shape of the projection 114 can help food move down the body 102 into the cutting mechanism 106. A skilled artisan can select a suitable shape for the projection 114 within the scope of the present disclosure. The projection 114 can be disposed opposite of the protrusion 116 within the interior surface 120 of the body 102. The placement of the projection 114 and protrusion 116 on opposite sides of the body 102 can allow for the food to quickly move toward the cutting mechanism 106. Advantageously, including the projection 114 and the protrusion 116 can allow for the food to move toward the bottom 110 of the body 102 faster than a singular protuberance. One of ordinary skill can select a suitable number of projections 114 for the interior surface 120 of the body 102.

With renewed reference to FIG. 9, the protrusion 116 can extend into the interior of the body 102 along the length L1 of the body 102. The protrusion 116 can increasingly protrude further into the interior of the body 102 along a length of the protrusion 116 toward the bottom 110 of the body 102. In this way, a bottom 126 of the protrusion 116 extends into the interior of the body 102 more than a top 128 of the protrusion 116, as shown in FIG. 6. The larger bottom 126 of the protrusion 116 can provide a singular point for larger pieces of food to accumulate. Desirably, while in use, as the cutting mechanism 106 rotates, it can contact the larger pieces of food that have accumulated on the protrusion 116 and militate against the larger pieces of food from just rotating within the cutting mechanism 106 and avoiding being cut. In this way, the protrusion 116 extending further into the interior of the body 102 toward the bottom 126 of the body 102 can provide a singular point of accumulation for larger foods and allow for the cutting mechanism 106 to come into direct contact with the food instead of the food continually spinning about the bottom of the body 102. A skilled artisan can select a suitable size and shape for the protrusion 116 to promote contact of the food with the cutting mechanism 106 within the scope of the present disclosure.

As shown in FIG. 9, the protrusion 116 can include a rounded top portion 130. The rounded top portion 130 can militate against food becoming stuck on the top 128 of the protrusion 116. Further, the rounded top portion 130 can allow for food to accumulate on the top 128 of the protrusion 116 and, once heavy enough, fall off the protrusion 116 toward the cutting mechanism 106 for juicing and blending. A skilled artisan can select a suitable arc for the rounded top portion 130 of the protrusion 116 within the scope of the present disclosure.

With reference to FIGS. 4-5, the body 102 can also include multiple ribs 118 disposed on the interior surface 120 of the body 102. A skilled artisan can select a suitable number of ribs 118 and a suitable placement of the ribs 118 within the scope of the present disclosure. In a particular embodiment, the multiple ribs 118 can include a first set of ribs 132 and a second set of ribs 134. The first set of ribs 132 can be disposed on a first side 136 of the body 102 between the projection 114 and the protrusion 116. The first set of ribs 132 can include a first rib 138, a second rib 140, and a third rib 142 disposed equidistant on the first side 136 of the body 102. The equal spacing of the first set of ribs 132 can militate against the food from moving around the bottom 110 of the body 102 to avoid the cutting mechanism 106 and aid in cutting the food into smaller parts during juicing and blending. It should also be noted that smaller, wet bits of cut food tend to stick to the smooth interior surface 120 of the body 102 and tend to accumulate on the ribs 118. Where the accumulation becomes large and heavy, the food falls off of the ribs 118 toward the cutting mechanism. To this point, the first set of ribs 132 provide an accumulation point for the smaller pieces of cut food on the first side 136 of the body 102 and assist with moving more food toward the cutting mechanism 106.

Similarly, the second set of ribs 134 can be disposed on a second side 144, shown in FIG. 4, of the body 102 between the protrusion 116 and the projection 114. The second set of ribs 134 can include a fourth rib 146, a fifth rib 148, and a sixth rib 150 disposed equidistant on the second side 144 of the body 102. The equal spacing of the second set of ribs 134 can militate against the food from moving around to avoid the cutting mechanism 106 and aid in cutting the food into smaller parts during juicing or blending. It should also be noted that smaller, wet bits of the cut food tend to stick to the smooth interior surface 120 of the body 102 and tend to accumulate on the ribs 118. Where the accumulation becomes large and heavy, the food falls off of the ribs 118 toward the cutting mechanism 106. To this point, the second set of ribs 134 can provide an accumulation point for the smaller pieces of cut food on the second side 144 of the body 102 and assist with moving more food toward the cutting mechanism 106.

Each of the multiple ribs 118 can be substantially the same in size and extend into the interior of the body 102 at a similar distance. The ribs 118 can also include a substantially triangular cross section or a substantially rectangular cross section, as shown in FIG. 5. The projection 114 and the protrusion 116 can extend further into the body 102 than the ribs 118, as shown in FIG. 4.

Additionally, the amount to which each of the ribs 118 extends outwardly from the interior surface 120 of the body 102 into the interior of the body 102 can be defined by a taper along the length L1 of the body 102 such that the ribs 118 extend from the interior surface 120 of the body 102 the most at the top 108 of the body 102. In this way, the ribs 118 can extend further into the interior of the body 102 toward the top of the body 102 and extend less into the interior of the body 102 toward the bottom of the body 102 adjacent the cutting mechanism 106. The tapering of the ribs 118 can correspond with the amount of food that is required to accumulate to fall off of the ribs. For example, a non-tapered portion of the rib 118 toward the top 108 of the body 102 can collect small bits of food faster than the tapered portion of the ribs. This collection or accumulation of small bits of food occurring faster allows for the food to clump together faster, become too heavy to remain on the interior surface 120 of the body 102, and fall toward the cutting mechanism 106. To this point, the non-tapered portion of the rib 118 at the top of the body allows for faster juicing and militates against food waste. Alternatively, should the ribs 118 not taper toward the bottom 110 of the body 102 and remain the same size throughout, too much food can accumulate toward the bottom of the rib 118 and can cause the bottom 110 of the body 102 and the cutting mechanism 106 to become clogged with clumps of the food. As such, the tapering of the ribs 118 militates against the bottom 110 of the body 102 and the cutting mechanism 106 to become clogged with clumps of the food. It should be noted that the ribs 118 taper in the opposite direction of the tapering of the protrusion 116. As described above, the protrusion 116 can allow for dense, large pieces of food to stop against the protrusion 116 for cutting by the cutting mechanism 106 and militate against the food continually rotating about the bottom of the body 102. Alternatively, the tapering of the ribs 118 allows for food collection along the interior sides of the body 102. The opposite direction tapering of the protrusion 116 and the ribs 118 works to promote that all the food is moved toward the cutting mechanism 106 and the efficiency of the hopper 100 is improved.

It should be noted that the ribs 118 can be sized to extend into the interior of the body 102 such that the ribs 118 collect small pieces of food but do not interfere with the blending process and do not collect too much food during use. In one non-limiting example, the ribs 118 can extend into the interior of the body 102 by less than a half of an inch. In a more particular example, the ribs 118 can extend into the interior of the body 102 by less than a third of an inch. A skilled artisan can select a suitable distance for the ribs 118 to extend into the interior of the body 102 within the scope of the present disclosure.

With renewed reference to FIG. 9, the ribs 118 can include an arced top portion 152. The arced top portion 152 can militate against food becoming stuck on the top of the rib 118. Further, the arced top portion 152 can allow for food to accumulate on the top of the rib 118 and, once heavy enough, fall off the rib 118 toward the cutting mechanism 106 for blending. A skilled artisan can select a suitable arc for the arced top portion 152 of the rib 118 within the scope of the present disclosure.

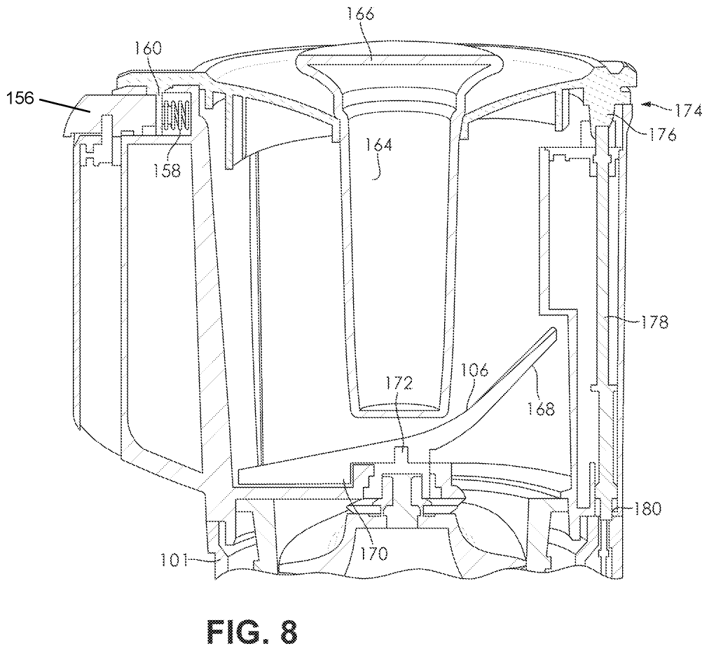

As shown in FIGS. 2-4, the body 102 can include a handle 154 disposed along the exterior surface 112 of the body 102. The handle 154 can be ergonomically shaped to allow for the user to easily grip the handle 154. A skilled artisan can select a suitable handle size and shape for the handle 154 within the scope of the present disclosure. The handle 154 can include a lock switch mechanism 156, shown in FIGS. 8-9. The lock switch mechanism 156 can include a spring 158 loaded such that where the user applies pressure to the lock switch mechanism 156, a tab 160 of the lid 104 can release, the spring 158 can be released, and the lid 104 can be lifted out of the lock switch mechanism 156. The lock switch mechanism 156 can keep the lid 104 of the hopper 100 closed while the juicer 101 is blending. Desirably, the lock switch mechanism 156 can maintain the lid in the closed position and militate against food exiting or spilling during the operation of the juicer 101.

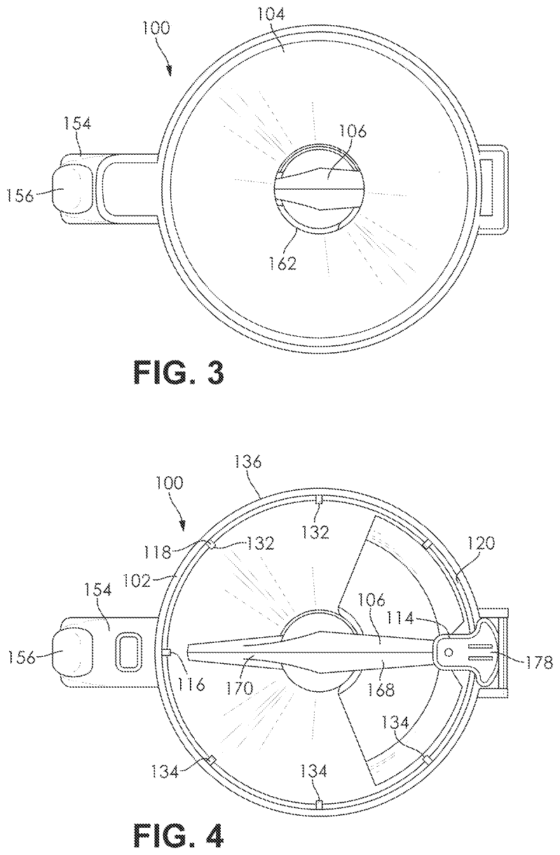

With continued reference to FIGS. 8-9, the lid 104 can be disposed adjacent to the body 102 and can be configured to be coupled to the body 102. The lid 104 can include a substantially circular cross section that corresponds with the substantially circular cross section of the body to allow for the lid 104 to close off the body 102 during use, as shown in FIG. 3. As further examples, the lid 104 can be domed or concave, as desired. A skilled artisan can select a suitable shape for the lid 104 within the scope of the present disclosure. The lid 104 can also be hingedly connected to the body. This can militate against the lid 104 becoming displaced from the body 102 while the hopper 100 is being loaded with food. The hinged lid 104 can also militate against the lid 104 separating from the body 102 when the user releases the lock switch mechanism 156.

As described herein, the lid 104 can include the tab 160 configured to hold the lid 104 closed. The lid 104 can also include a hole 162 that can allow the user to add food to the body 102 while the hopper 100 is in use and the juicer 101 is blending food. Advantageously, this can allow the user to quickly add food and militate against the juicer 101 being turned on and off repeatedly during a single use. One of ordinary skill can select a suitable size for the hole 162 to promote easy addition to the body 102 within the scope of the present disclosure.

In certain embodiments, the hopper 100 can further include a pusher 164 for moving food around during use of the juicer 101. The pusher 164 can be shaped to allow for the pusher 164 to be inserted through the hole 162 disposed on the lid 104. In operation, as food is fed through the hole 162, the user can use the pusher 164 to direct the food toward the cutting mechanism 106. The pushing forces applied by the user via the pusher 164 can direct the food onto the cutting mechanism 106 to process the food. The pusher 164 can further include a flange 166, as shown in FIGS. 2 and 8, which can allow for the pusher 164 to rest in the hole 162 of the lid 104 without falling into the body 102 while the hopper 100 is in use or during storage. The flange 166 can further act as a handle for the user to grasp while using the pusher 164. To this point, the flange 166 can be ergonomically shaped to fit in the palm of the user. Advantageously, this can provide an easier juicing experience by giving the user more dexterity when pushing the food around within the body 102.

As shown in FIG. 8, the cutting mechanism 106 can be disposed within the interior of the body 102. The cutting mechanism 106 can be adapted to rotate about the center of the body 102. The preferred cutting mechanism 106 is suitable for chopping or crushing ice and juicing or blending food. The cutting mechanism 106 can include a blade 168 and an agitator 170. The blade 168 can include a substantially triangular cross section and can have a sharp edge for cutting fruit. The blade 168 can be disposed at an incline and extend upwardly from the center of the cutting mechanism 106. The blade 168 can be disposed in a plane parallel to a second plane in which the bottom 126 of the body 102 is contained.

With continued reference to FIG. 8, the agitator 170 can be disposed opposite the blade 168 on the cutting mechanism 106. The agitator 170 can have a blunt edge and can assist with moving food that is stuck on the bottom of the interior surface 120 of the body 102 and therefore, avoiding the blade 168 for cutting. The agitator 170 can have an inclined leading edge and can abut the center of the juicer 101, as shown in FIG. 8. Advantageously, because the agitator 170 abuts the center of the juicer 101, fruit pieces on the bottom 110 of the body 102 can be moved around and eventually pushed out the bottom 110 of the body 102 by the agitator 170.

As shown in FIG. 8, the cutting mechanism 106 can be held in place by a fastening means 172. In certain embodiments, the fastening means 172 can be disposed between the body 102 and the cutting mechanism 106. In an alternative embodiment, not show, the fastening means 172 can be disposed above the cutting means 106 at an incline to militate against food collecting on top of the fastening means 172 and not moving to the cutting mechanism 106 to be blended. More particularly, the fastening means 172 can be rounded to militate against food collecting on the fastening means and not moving to the cutting mechanism 106 to be blended.

With reference to FIGS. 8-9, the hopper 100 can also include a safety mechanism 174 disposed adjacent to the lid 104 and housed in the projection 114 opposite the handle 154 of the hopper 100. The safety mechanism 174 can include a cam 176. The cam 176 can be integrated into the lid 104 and can push a spring-loaded push rod 178. The bottom of the push rod 178 can have a magnet, which can trigger a Hall sensor 180 on the body 102 such that where the magnet passes through the Hall sensor 180, the Hall sensor 180 can be triggered and allow for operation of the juicer 101. The Hall sensor 180 can pick up a magnetic field and can allow for the operation of the juicer 101. Therefore, when the lid 104 is open, the cam 176 does not push down on the push rod 178, the Hall sensor 180 is not triggered, and the juicer 101 cannot operate, as shown in FIG. 9.

With renewed reference to FIGS. 8-9, the hopper 100 can be configured for cooperative engagement with the juicer 101. The juicer 101 can include a drive shaft that can be in cooperative engagement with the cutting mechanism 106 and can drive the cutting mechanism 106 while in use. Further, the juicer 101 can include a motor that can be in communication with the safety mechanism 174. In this way, the safety mechanism can control the operation of the motor and militate against the motor working to power the juicer 101 and, hence, the cutting mechanism 106, where the safety mechanism 174 is not engaged.

The hopper 100 is preferably formed of a rigid material that is transparent or translucent plastic material to allow for the user to view the blending in operation. Further the hopper 100 is preferably formed of a non-porous material to allow for easy clean up by the user after using the juicer 101 to juice or blend food. A skilled artisan can select a suitable material within the scope of the present disclosure.

In operation, a given quantity of ice, liquid, and/or food is placed is placed into the body 102 and the juicer 101 is turned on. As the cutting mechanism 106 rotates, the blade 168 and the agitator 170 describe an imaginary circle of rotation extending at a constant distance relative to the interior surface 120 of the body 102. The cutting mechanism 106 can chop the ice and/or food into small particles and thoroughly juice and blend them with the liquid ingredients to form a drink-like consistency. Remaining pieces of food can contact the blade 168 of the cutting mechanism 106. As the food and drink-like mixture move around the interior surface 120 of the body 102, the projection 114, the protrusion 116, and the ribs 118 assist in deflecting unblended food inwardly toward the blade 168 of the cutting mechanism 106, facilitated by the tapered wall surfaces of the projection 114, the protrusion 116, and the ribs 118 positioned on the interior surface 120 of the body 102.

The portion of the food being fed back to the blade 168 of the cutting mechanism 106 is picked up by the blade 168 and the process is repeated as long as the cutting mechanism 106 is rotating. After the ice and food is crushed and thoroughly juiced and/or blended with the liquid ingredients to form the drink-like consistency, the blade 168 can be rotated at a slower speed to maintain the drink-like consistency and to prevent the formation of clumps of ice. Rotation of the blade 168 also prevents the liquid from separating from the ice particles.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A hopper for a vertical juicer for food, comprising:
a body including a projection, a protrusion, and a rib, wherein the projection, the protrusion, and the rib are disposed on an interior surface of the body;
a lid coupled to the body, the lid including a hole configured to receive food therethrough; and
a cutting mechanism rotatably coupled to the interior surface of the body and configured to cut food.

2. The hopper of claim 1, wherein the projection includes a cutout disposed along a length of the vertical juicer and configured to accommodate rotation of the cutting mechanism therethrough.

3. The hopper of claim 2, wherein the cutout includes a rectangular cross section within an interior of the body.

4. The hopper of claim 1, wherein the projection is disposed opposite the protrusion on the interior surface of the body.

5. The hopper of claim 1, wherein the projection includes a substantially rectangular cross section.

6. The hopper of claim 1, wherein the rib is comprised by a plurality of ribs disposed on the interior surface of the body.

7. The hopper of claim 6, wherein the plurality of ribs includes a first set of ribs and a second set of ribs, the first set of ribs disposed on a first side of the body between the projection and the protrusion and the second set of ribs disposed on a second side of the body between the protrusion and the projection.

8. The hopper of claim 7, wherein the first set of ribs includes a first rib, a second rib, and a third rib, where the first rib, the second rib, and the third rib are disposed equidistant on the first side between the projection and the protrusion.

9. The hopper of claim 8, wherein the second set of ribs includes a fourth rib, a fifth rib, and a sixth rib, where the fourth rib, the fifth rib, and the sixth rib are disposed equidistant on the second side between the protrusion and the projection.

10. The hopper of claim 1, wherein the lid is hingedly coupled to the body.

11. The hopper of claim 1, where the body includes a handle disposed on an exterior of the body.

12. The hopper of claim 11, wherein the handle includes a lock switch mechanism.

13. The hopper of claim 1, wherein the ribs and the protrusion taper in opposite directions along the interior surface of the body.

14. The hopper of claim 1, wherein the hopper includes a safety mechanism.

15. The hopper of claim 1, wherein the lid includes a tab configured to be received by the body.

16. The hopper of claim 1, wherein the cutting mechanism includes a blade and an agitator.

17. The hopper of claim 16, wherein the agitator includes a substantially triangular cross section.

18. The hopper of claim 16, wherein the agitator includes a blunt edge.

19. The hopper of claim 16, wherein a bottom surface of the hopper is disposed in a first plane, the agitator is disposed in a second plane, and the first plane and the second plane are parallel.

20. A hopper for a vertical juicer for food, comprising:
a body including
a projection having a rectangular cross section within an interior surface of the body,
a protrusion disposed opposite the projection on the interior surface of the body,
a plurality of ribs disposed on the interior of the body and including a first set of ribs and a second set of ribs, the first set of ribs disposed on a first side of the body between the projection and the protrusion and the second set of ribs disposed on a second side of the body between the protrusion and the projection,
a cutout disposed on the interior of the body and adjacent to the projection,
a handle disposed on an exterior of the body and including a lock switch mechanism, and
a safety mechanism;
a lid disposed adjacent to the body and hingedly coupled to the body, the lid including a hole configured to receive food therethrough and a tab configured to be received by the body; and
a cutting mechanism disposed in the body and configured to cut food, the cutting mechanism including a blade and an agitator,
wherein the cutout is configured to receive the cutting mechanism, and
wherein the plurality of ribs and the protrusion taper in opposite directions along the interior surface of the body.
